(19) United States
(12) Patent Application Publication
(10) Pub. No.: US 2021/0137028 A1
(43) Pub. Date: May 13, 2021

(54) METHOD AND APPARATUS FOR AUTONOMOUS INDOOR FARMING

(71) Applicant: 80 ACRES URBAN AGRICULTURE, INC., Hamilton, OH (US)

(72) Inventors: Michael ZELKIND, Cincinnati, OH (US); Patricia LIVINGSTON, Cincinnati, OH (US); Tracy Alan CANIPE, Hickory, NC (US); Joseph Michael PORTELLO, Fayetteville, AR (US)

(21) Appl. No.: 17/098,283

(22) Filed: Nov. 13, 2020

Related U.S. Application Data
(60) Provisional application No. 62/934,942, filed on Nov. 13, 2019.

(51) Int. Cl. A01G 9/26; A01G 9/24; A01G 9/02; A01G 31/00; A01G 7/04; G06N 20/00; G05B 19/4155; B65G 1/137

(52) U.S. Cl. CPC A01G 9/26; A01G 9/246; A01G 9/249; A01G 9/247; A01G 9/027; A01G 9/023; B25J 5/02; A01G 7/045; G06N 20/00; G05B 19/4155; B65G 1/137; A01G 2031/006; G05B 2219/40191; A01G 31/00

(57) ABSTRACT

An autonomous farming system includes a computing device that is configured to obtain plant characteristic data that characterizes one or more plant characteristics of a plant growing in at least one growing module. The computing device is further configured to determine at least one growing deficiency of the plant based on the plant characteristic data using a farming engine and to send at least one farming action to a farming controller operatively coupled to the at least one growing module. The at least one farming action includes a remedial action to improve growing conditions of the plant.

### CROSS-REFERENCE TO RELATED APPLICATIONS

This application claims the benefit of U.S. Provisional Application No. 62/934,942, filed on Nov. 13, 2019. The entire disclosure of the above application is incorporated herein by reference.

### TECHNICAL FIELD

This disclosure relates generally to indoor farming systems and, more particularly, to a method and apparatus for an autonomous indoor farming system.

### BACKGROUND

Global food production systems need to address significant challenges in the coming decades. Finding ways to feed a growing global population whilst reducing environmental impact of agricultural activities is of critical importance. Controlled environment agriculture (CEA), which includes greenhouses and indoor farming, offers a realistic alternative to conventional production for some crops. Vertical indoor farming allows for faster, more controlled production, irrespective of season. Further, vertical indoor farming is not vulnerable to other environmental variability such as pests, pollution, heavy metals, and pathogens. Vertical indoor farming can also reduce environmental impact offering no loss of nutrient, reduced land requirement, better control of waste, less production loss, reduced transportation cost, and reduced clean water usage. Therefore, vertical indoor farming can help to address the significant challenges.

Current methods and systems for vertical indoor farming, however, are relatively expensive to implement and do not efficiently utilize the available space within a room or container for growing crops. For example, to implement an indoor farming system, an enclosed room or container must be provided and thereafter configured for growing crops or plants in a controllable environment. Environmental parameters such as lighting, temperature, humidity and airflow are controllable within the room or container to achieve the benefits of indoor farming discussed above. Such environmental control, however, requires relatively expensive sensor and control systems. Additionally, shelving and/or racks for holding the plants must be placed within the room or container, and for rooms or containers having a relatively large size, space is allocated within the room or container for allowing human operators to walk inside the enclosed room or container to access each of the shelves and/or racks. Thus, much of the space within the room or container is not allocated for growing plants but instead for allowing human access and movement within the room or container. This is an inefficient utilizing of expensive space within an enclosed room or container for growing plants/crops.

Additionally, current methods and systems for vertical indoor farming are not able to operate autonomously. Current methods and systems cannot evaluate the conditions of the growing plants and adjust the environment within the grow zones to best accommodate the needs of the growing plants based on the conditions of the plants. Current methods and systems are not able to learn from previous growing cycles to modify and adjust the environment within the grow zone to optimize the conditions for the growing plants within the grow zone. Current methods and systems for vertical indoor farming are not able to learn from previous grow cycles to automatically adjust the environment within the grow zones in response to the condition and health of the growing plants within. Therefore, current methods and systems for indoor farming are not entirely satisfactory.

### SUMMARY

This section provides a general summary of the disclosure, and is not a comprehensive disclosure of its full scope or all of its features.

In some embodiments in accordance with the present disclosure, an autonomous farming system can include a computing device that is configured to obtain plant characteristic data that characterizes one or more plant characteristics of a plant growing in at least one growing module and to determine at least one growing deficiency of the plant based on the plant characteristic data using a farming engine. The computing device can also be configured to send at least one farming action to a farming controller operatively coupled to the at least one growing module, wherein the at least one farming action comprises a remedial action to improve growing conditions of the plant.

In one aspect, the farming engine can include a trained machine learning model.

In another aspect, the plant characteristic data can be collected by one or more sensors located in the at least one growing module.

In another aspect, the computing device can be configured to obtain plant environmental data characterizing the growing conditions of the plant inside the at least one growing module and the at least one growing deficiency can be determined based on the plant environmental data.

In another aspect, the farming engine can include a machine learning model trained using historical plant characteristic data and historical environmental data.

In another aspect, the farming controller can be operatively coupled to at least one of an air circulation system, a lighting system, an irrigation system, a vision system and a liquid circulation system.

In another aspect, the at least one farming action can include instructions that cause the at least one of the air circulation system, the lighting system, the irrigation system, the vision system and the liquid circulation system to change the growing conditions in the growing module.

In another aspect, the plant characteristic data can include image data collected by a vision system in the growing module wherein the image data includes images of the plants in the growing module.

In another aspect, the farming engine can automatically determine the at least one deficiency of the plant based on historical image data.

In another aspect, the computing device can be configured to re-train a machine learning model of the farming engine and replace an initial machine learning model with a re-trained machine learning model when the computing device determines that a performance of the re-trained machine learning model exceeds a performance of the initial machine learning model.

In another aspect, the at least one growing module includes a plurality of growing containers and the plurality of growing containers are arranged in at least two columns and at least two rows to define a matrix of growing containers. The computing device can also obtain plant characteristic data that characterizes one or more plant characteristics of a plant growing in each of the plurality of growing containers.

In some embodiments in accordance with the present disclosure, a method of autonomous is provided. The method of autonomous farming can include obtaining plant characteristic data that characterizes one or more plant characteristics of a plant growing in at least one growing module and determining at least one growing deficiency of the plant based on the plant characteristic data using a farming engine. The method can also include sending at least one farming action to a farming controller operatively coupled to the at least one growing module, wherein the at least one farming action comprises a remedial action to improve growing conditions of the plant.

In some embodiments in accordance with the present disclosure, an autonomous farming apparatus may include a plurality of enclosed growing containers each having an independently controllable environment wherein the plurality of enclosed growing containers are oriented in at last two columns and at least two rows to define a matrix of growing containers. The autonomous farming apparatus can also include at least one movable cart positioned in each of the plurality of enclosed growing containers in which each of the at least one movable cart configured to hold one or more plants. An articulated robot can be movably positioned on a track and on a riser such that the articulated robot can move in a first direction along the track to access each column in the matrix of growing containers and can move in a second direction along the riser to access each row in the matrix of growing containers.

In another aspect, the articulated robot can extract and insert the at least one movable cart from each growing container in the matrix of growing containers.

In another aspect, each growing container in the matrix of growing containers can include at least two tiers configured to support the at least one movable cart at different positions relative to a bottom of the growing container.

In another aspect, the autonomous farming apparatus can also include a computing device and a farming controller. The computing device can be coupled to the farming controller and configured to determine at least one deficiency of the one or more plants using a trained machine learning model.

In another aspect, the computing device can determine the at least one deficiency based on plant characteristic data obtained from one or more sensors located in each of the growing modules.

In another aspect, the computing device can determine the at least one deficiency further based on environmental data obtained from one or more sensors located in each of the growing modules.

In another aspect, the machine learning model can be trained using historical plant characteristic data and historical environmental data obtained from sensors located in each of the growing modules.

In another aspect, the computing device can send a farming action to one of an air circulation system, a lighting system, an irrigation system, a vision system and a liquid circulation system located in one of the plurality of growing modules to cause the one of the air circulation system, the lighting system, the irrigation system, the vision system and the liquid circulation system to change a growing condition in the one of the plurality of growing modules.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Aspects of the invention are best understood from the following detailed description when read with the accompanying figures. It is noted that various features are not necessarily drawn to scale. In fact, the dimensions and geometries of the various features may be arbitrarily increased or reduced for clarity of illustration.

FIGS. 1A-1D illustrate perspective views of an autonomous indoor farming facility, in accordance with some embodiments.

FIG. 2 illustrates a perspective view of an indoor farming module, in accordance with some embodiments.

FIG. 3 illustrates an exemplary perspective view of an indoor farming module open at one end to reveal a plurality of vertical layers of plant trays, each vertical layer having a plurality of rows of plant trays and extending across an entire interior width of the module, in accordance with some embodiments.

FIGS. 4A-4C illustrate exemplary end views of an indoor farming module, in accordance with some embodiments.

FIG. 5 illustrates a perspective view of an autonomous indoor farming facility, in accordance with some embodiments.

FIG. 6A illustrates a system block diagram of an autonomous indoor farming system, in accordance with some embodiments.

FIG. 6B illustrates an exemplary block diagram of a controller in an indoor farming facility, in accordance with some embodiments.

FIG. 7 illustrates a block diagram of an artificial intelligence (AI) system for an autonomous indoor farming, in accordance with some embodiments.

FIG. 8 illustrates a block diagram of aspects of the autonomous farming system of FIG. 6A, in accordance with some embodiments.

FIG. 9 is an illustration of a plant and an example indicator of a deficiency, in accordance with some embodiments.

FIG. 10 is an illustration of a fruit and an example indicator of a deficiency, in accordance with some embodiments.

FIG. 11 is an illustration of another plant and an example indicator of a deficiency, in accordance with some embodiments.

FIG. 12 is an illustration of another plant and an example indicator of a deficiency, in accordance with some embodiments.

FIG. 13 is an illustration of another plant and an example indicator of a deficiency showing progression over time, in accordance with some embodiments.

FIG. 14 is a flow chart showing an example method of autonomous farming, in accordance with some embodiments.

FIG. 15 is a flow chart showing another example method of autonomous farming, in accordance with some embodiments.

FIG. 16 is a flow chart showing an example method of re-training a machine learning model, in accordance with some embodiments

### DETAILED DESCRIPTION OF EXEMPLARY EMBODIMENTS

Various exemplary embodiments of the invention are described below with reference to the accompanying figures to enable a person of ordinary skill in the art to make and use the invention. As would be apparent to those of ordinary skill in the art, after reading the present disclosure, various changes or modifications to the examples described herein can be made without departing from the scope of the invention. Thus, the present invention is not limited to the exemplary embodiments and applications described or illustrated herein. Additionally, the specific order or hierarchy of steps in the methods disclosed herein are merely exemplary approaches. Based upon design preferences, the specific order or hierarchy of steps of the disclosed methods or processes can be re-arranged while remaining within the scope of the present invention. Thus, those of ordinary skill in the art will understand that the methods and techniques disclosed herein present various steps or acts in a sample order, and the invention is not limited to the specific order or hierarchy presented unless expressly stated otherwise.

Embodiments of the present invention are described in detail with reference to the accompanying drawings. The same or similar components may be designated by the same or similar reference numerals although they are illustrated in different drawings. Specific examples of components and arrangements are described below to simplify the present disclosure. These are, of course, merely examples and are not intended to be limiting. For example, it will be understood that when an element is referred to as being “connected to” or “coupled to” another element, it may be directly connected to or coupled to the other element, or one or more intervening elements may be present.

FIGS. 1A-1D illustrate perspective views of an autonomous indoor farming facility 100, in accordance with some embodiments. In the illustrated embodiments, the autonomous indoor farming facility 100 comprises 10 indoor farming modules 102 arranged in 5 columns and each column comprises 2 stacked indoor farming modules 102. In the illustrated embodiments, the autonomous indoor farming facility 100 comprises at least one tray-handling system designed for automatically loading and unloading carts through a first end of the indoor farming module 102. In some other embodiments, the tray-handling system is further designed for automatically planting and removing individual crops from a cart.

In the illustrated embodiment, the tray-handling system comprises an articulated robot 104, two linear transfer systems 106/108, a track 110, and a robot controller (not shown). In some embodiments, the tray-handling system is configured to transfer a predetermined cart from the chassis in the indoor farming module 102 to a predetermined position (e.g., a storage rack). In some embodiments, when inserting new crops into the indoor farming module 102, the tray-handling system is configured to transfer a predetermined cart from the storage rack to the chassis of the indoor farming module 102.

In some embodiments, the indoor farming module 102 comprises at least one of the following sub-systems: an air circulation system, a lighting system, an irrigation system, a liquid circulation system, a vision system, a controller, and a local computer, to provide controllable environment to crops in the indoor farming module 102. Each of the at least one of the subsystems in the indoor farming module 102 is discussed in detail below.

In some embodiments, the articulated robot 104 is configured outside of the indoor farming module 102 in the autonomous indoor farming facility 100. In some embodiments, the articulated robot 104 comprises a plurality of joints for controlling a plurality of arm segments coupled to corresponding joints. In some embodiments, each of the plurality of joints is coupled to an electric motor (not shown) for providing rotational motion to each of the plurality of joints. In some embodiments, the articulated robot 104 has a plurality of axes allowing the articulated robot 104 to access and accurately load and unload carts in the plurality of indoor farming modules 102. In some embodiments, the articulated robot 104 comprises a fork-type attachment to detachably couple a cart during the transfer, which is discussed in further detail below.

In some embodiments, the robot controller is configured to manage and operate the tray-handling system according to a predetermined rule or a prescheduled task. In some embodiments, the pre-determined rule or the pre-scheduled task is determined according to the growth condition and growth stage of the plants in the tray on the cart, wherein the growth condition and growth stage are monitored in real-time through the vision system or predicted by a machine learning model as discussed in detail below. In some embodiments, a second robot 112 can be configured adjacent to the articulated robot 104 or the storage rack 114/116 to move the tray out of the cart so that the plants in the tray can be harvested and the cart can be reused. In some embodiments, the robot controller comprises a motion-planning unit, which is used to determine trajectories of the robot so as to move the predetermined tray to a predetermined location and register any changes in positions of other trays in the transferring process of the predetermined tray. In some embodiments, the robot controller is coupled to a cloud computer, which further receives instructions from a controller in the indoor farming module 102 and/or a remote control station. For example, when a cart is determined to be unloaded from the indoor farming module 102, the controller of the indoor farming module 102 pauses the irrigation schedule, rotates a plurality of liquid distribution tube assemblies, and opens a roll-up door 120 at a first end 130 of the indoor farming module 102, before the articulated robot 104 can be initiated.

As shown in FIG. 1A, the farming facility 100 can include many farming modules 102 arranged in multiple rows and in multiple columns. In the example shown, the farming facilities includes ten farming modules 102 with five farming modules positioned at one level in a first row and five additional farming modules 102 positioned in a second row on top of the first row. In this arrangement, the farming modules define a matrix of farming modules or a matrix of growing containers 102. The robot 104 is positioned on track 110 and on a riser 108 such that the robot 104 can be moved to any desired position relative to the matrix of farming modules 102. The support 106 can be moved in a vertical direction along the riser 108 and the riser 108 can be moved along the track 110. In this manner, the robot 104 can be moved and or articulated to each farming module 102 in the matrix to access the plants in the farming modules at any desired row and column of the matrix. In other examples, the matrix can have different sizes and can include more than two rows and five columns. In still other examples, the matrix can less than five columns.

In some embodiments, each of the plurality of indoor farming modules 102 can be accessed from a second end 140, wherein the second end 140 is configured with an access door for maintenance purposes. In some embodiments, in order to access the stacked indoor farming modules 102, stairs 122 are further configured at the second end 140 of the indoor farming module 102.

FIG. 2 illustrates a perspective view of a container or enclosure 200 that may be utilized to provide an indoor farming module, in accordance with some embodiments. In some embodiments, the container 200 is a standard shipping container used for shipping merchandise across oceans or seas, typically on cargo tankers, and thereafter loadable and shipped on land via “18-wheeler” trucks. Such standard shipping containers are ubiquitous today and used shipping container can be purchased at relatively inexpensive prices. Thus, “ready-made” containers that are relatively inexpensive can be retrofitted into indoor farming modules 200, in accordance with various embodiments of the invention, as described in further detail below. The standard shipping containers 200 are typically constructed of steel and are fully enclosed. As shown in FIG. 2, a typical shipping container 200 is in the form an elongated rectangular box having a roof 202, floor 206, two side walls 204, a front wall 230 and a rear wall 240. In some embodiments, double doors (not shown) are provided on the front wall 230 to allow access to crops or plants (hereinafter collectively referred to as “crops”) to accessed (e.g., loaded, unloaded, inspected, treated, etc.) within the container 200. Various types of doors (e.g., single, double, garage-type door, rolling-type door, etc.) can be retrofitted onto the front wall 230 as desired, or the existing doors of the standard shipping container 200 can be used. Similarly, the rear wall 240 can be retrofitted with various types of doors to allow personnel to access environmental control systems and equipment located at the rear area of the container 200.

Standard shipping containers 200 typically have a length (L) of 40 feet, a height (H) of 9 feet and 6 inches, and a width (W) of 8 feet. The inventors have discovered that the dimensions of standard shipping containers 200, especially when occupied to maximum capacity with crops and provided with environmental controls for year-round farming, provide a cost-effective approach to indoor farming. However, it is understood that in alternative embodiments, the invention is not limited to retrofitting standard shipping containers to provide indoor farming modules. Other types of enclosures or containers having similar or different dimensions, and made with the same or different materials, can be utilized based on the principles of the invention disclosed herein, in accordance with various alternative embodiments of the invention.

FIG. 3 illustrates an exemplary perspective view of an indoor farming module 300 with the front wall 230 opened or removed for purposes of showing an interior compartment of the container 200, in accordance with some embodiments of the invention. In the illustrated embodiments, an air circulation system, a liquid circulation system, and a lighting system, which are discussed separately in detail below, are omitted in the indoor farming module 300 for clarity of illustration purposes. As shown in FIG. 3, the indoor farming module 300 comprises an interior compartment 302. In some embodiments, the module 300 is a standard refrigerated shipping container that is retrofitted for indoor farming, as described in further detail below. In the illustrated embodiment, the indoor farming module 300 comprises a chassis 304. In some embodiments, the chassis 304 comprises a plurality of vertical frames and a plurality of horizontal frames. In the illustrated embodiments, the chassis 304 comprises four tiers, i.e., a first tier 306-1, a second tier 306-2, a third tier 306-3 and a fourth tier 306-4. Each of the four tiers 306 of the chassis 304 extends from a first wall 308-1 to a second wall 308-2 of the interior compartment 302 in a first direction (i.e., x direction). In some embodiments, the first wall 308-1 and the second wall 308-2 are sidewalls along the long side of the interior compartment 302.

Each of the four tiers 306 of the chassis 304 comprises three pairs of guide rails 310 extending along a second direction (i.e., y direction) perpendicular to the first direction (i.e., x-direction). In some embodiments, the three pairs of guide rails 310 are parallel and configured side-by-side to one another so that the three pairs of guide rails in a tier 306 occupy the entire width of the container compartment 302 (i.e., space between the first wall 308-1 and the second wall 308-2).

In the illustrated embodiments, a plurality of carts 312 with wheels sized and spaced to roll on the pair of guide rails 310 are installed on the chassis 304. Each of the plurality of carts 312 is detachably linked to an adjacent cart 312 on the same pair of guide rails 310 through a cart coupler (not shown). In some embodiments, the cart coupler is also configured to be coupled and secured to an articulated robot when being transferred. Each of the plurality of carts 312 in the indoor farming module 300 is configured to carry a tray, which contains a seed pod (not shown) in which a plurality of plants are planted. In some embodiments, the seed pod comprises a plurality of holes and an arrangement of holes is determined according to a growth condition of the plurality of plants. In some embodiments, each of the three pairs of guide rails 310 can carry eight carts and the indoor farming module 300 can carry a maximum number of 96 carts.

A lighting assembly and a water circulation assembly are mounted on the plurality of horizontal frames of the chassis 304 so as to provide light illumination and liquid supply to each of the trays in the corresponding cart, in accordance with some embodiments, and as discussed in further detail below in FIGS. 4A-4C. In some embodiments, the indoor farming module 300 is fully closed using a roll-up door (not shown) on a first end so as to maintain the growth condition (e.g., humidity, temperature, CO₂ level, etc.) within a fully enclosed environment. The roll-up door is opened when a cart is being transferred in or out of the interior compartment 302, for example. It is noted that the indoor farming module 300 illustrated in FIG. 3, is merely an example, and is not intended to limit the invention. Accordingly, it is understood that a chassis in the indoor farming module 300 of FIG. 3 can be configured with any numbers of tiers 306, any numbers of guide rails 310, and can carry any numbers of carts 312, in accordance with various embodiments of the invention.

FIGS. 4A-4C illustrate exemplary end views of an indoor farming module 400 with an air circulation system, a water circulation system, a lighting system and a control system, in accordance with some embodiments of invention. It is noted that the indoor farming module 400 illustrated in FIGS. 4A-4C, is merely an example, and is not intended to limit the invention. Accordingly, it is understood that additional functional blocks may be provided in or coupled to the indoor farming module 400 of FIGS. 4A-4C, and/or some other functional blocks may be omitted.

In the illustrated embodiment, the indoor farming module 400 comprises a chassis 304 with four tiers in a container compartment 302, i.e., a first tier 306-1, a second tier 306-2, a third tier 306-3 and a fourth tier 306-4. In some embodiments, the chassis 304 comprises a plurality of vertical frames and a plurality of horizontal frames. Each of the four tiers 306 of the chassis 304 extends from a first wall 308-1 to a second wall 308-2 of the indoor farming module 400 in a first direction (i.e., x direction). Each of the four tiers 306 of the chassis 304 comprises three pairs of guide rails 310 extending along a second direction perpendicular to the first direction. The three pairs of guide rails 310 are configured side-by-side to one another so that the three pairs of guide rails in a tier 306 span across the entire width of the interior compartment 302 in the first direction.

Each of the plurality of carts 312 in the indoor farming module is configured to carry a tray, which contains a seed pod 402 with a plurality of plants 404 planted therein. In some embodiments, the seed pod 402 comprises an array of holes (not shown) and an arrangement of holes is determined according to a growth condition of the plurality of plants 404. In some embodiments, each of the three pairs of guide rails 310 can carry eight carts and the indoor farming module 400 can carry 96 carts. It is noted that the indoor farming module 400, is merely an example, and is not intended to limit the invention. Accordingly, it is understood that a chassis 304 in the indoor farming module 400 of FIGS. 4A-4C can be configured with any numbers of tiers 306, any numbers of pairs of guide rails 310, and any number of carts 312, which can be sized appropriately for each configuration.

In the illustrated embodiment, each of the 96 carts in the indoor farming module 400 is provided with a lighting assembly 406 and a liquid circulation assembly 408. In the illustrated embodiment, the lighting assembly 406 and the liquid circulation assembly 408 are structurally supported on the corresponding horizontal frame over each of the plurality of carts 312 and over a floor 410. In the illustrated embodiments, the liquid circulation assembly 408 comprises a plurality of liquid supply conduits, a plurality of liquid return conduits, a plurality of liquid distribution tube assemblies, a plurality of drainage conduits, and a plurality of stepper motor assemblies. An example of such a configuration is described in more detail in U.S. patent application Ser. No. 16/870,675 filed on May 8, 2020, which is incorporated by reference as though fully set forth herein. In some embodiments, the lighting assembly 406 comprises at least one lighting module, which is discussed in further detail below. In some embodiments, the plurality of drainage conduits are coupled together to a drainage collection conduit 412 and further connected to external drainage container.

In some embodiments, the indoor farming module 400 comprises an air circulation system, which comprises an air blowing/conditioning unit 424, at least one air dehumidifying unit 426, and a control unit 428. In some embodiments, the air blowing unit 424 is coupled to a drop ceiling 420. In some embodiments, the air blowing/conditioning unit 424 is sized based on plant mass and container volume. In some embodiments, the air blowing/conditioning unit 424 is used to condition the atmosphere in grow zones in the indoor farming module and is sized based on heat generated from a lightning assembly. In some embodiments, the air blowing/conditioning unit 424 produces cool dry air which is then pulled into the recirculation fans and is distributed into the drop ceiling 420 located at the top of the grow zones. In some embodiments, the drop ceiling 420 has gaps along the left and right hand sides to facilitate air movement. When the cool air enters the drop ceiling 420, it becomes pressurized which then becomes a positive displacement. The displacement causes a portion of the air to be distributed down the side walls. In some embodiments, a motorized damper controls the volume of the remaining air exiting the rear of the plenum. In some embodiments, predetermined set points in the control program adjust airflow as plant mass increases during different stages of the growth cycle. In this design, this air circulation system works as a push-pull air exchange that is picking up heat and humidity as it travels back to be reconditioned.

In some embodiments, the air flow is controlled by the controller 428, which can dynamically adjust the air flow according to plant mass as it increases during different stages of a growth cycle. As the dry and cool air enters space between tiers, humidity and temperature of the air flow increase. In some embodiments, the at least one air dehumidifying unit 426 receives humid air return from the grow zones and provides dry air to the air blowing/conditioning unit 424 over the drop ceiling 424 of the interior compartment 302. Water condensed from the dehumidifying process is drained to a collection reservoir (not shown) for filtering and recycling. Thus, the air circulation system described above, and illustrated in FIGS. 4A-4C, facilitates the control of environmental parameters such as temperature, humidity, air content, etc., to precisely control and maintain optimal growing conditions within the interior compartment 302 depending on the types of crops being grown and the state of their growth cycle, in accordance with various embodiments of the invention.

FIG. 5 illustrates a perspective view of an autonomous indoor farming facility 500, in accordance with some embodiments. In the illustrated embodiments, the autonomous indoor farming facility 100 comprises 22 indoor farming modules 102 arranged in a plurality of columns and some of the plurality of columns comprises two stacked indoor farming modules 102. In the illustrated embodiments, the autonomous indoor farming facility 500 comprises one tray-handling system 502. In the illustrated embodiment, the tray-handling system 502 comprises an articulated robot, two linear transfer systems, a track, and a robot controller (not shown), as described above. In some embodiments, the tray-handling system 502 is configured to transfer a predetermined cart from the chassis in the indoor farming module 102 to a predetermined position (e.g., a storage rack). In some embodiments, when inserting new crops into the indoor farming module 102, the tray-handling system is configured to transfer a predetermined cart from the storage rack to the chassis of the indoor farming module 102 on both sides of the track. In some other embodiments, the tray-handling system 502 is further designed for automatically planting and removing individual crops from a cart. It should be noted that the embodiment shown in FIG. 5 is for illustration purposes and not to limit the scope of this invention. There can be any number of indoor farming modules 102 in the autonomous indoor farming facility 500, and there can be any number of tray-handling systems 502. In some other embodiments, the tray-handling systems 502 does not comprise a track, in which case the motion of the tray-handling system 502 can be navigated through one of the following techniques, wired, guide tape, laser, gyroscope, and vision systems. In some embodiments, the tray-handling system 502 can be powered by batteries which can be wirelessly charged.

FIG. 6A illustrates a system block diagram of an autonomous indoor farming system 600, in accordance with some embodiments of the invention. It is noted that the autonomous indoor farming system 600 is merely an example, and is not intended to limit the invention. Accordingly, it is understood that additional functional blocks may be provided in or coupled to the system 600 of FIG. 6A, and that some other functional blocks may be omitted or only briefly described herein. It should be also noted that the functionalities provided in each of the components and modules of the system 600 can be combined or separated into one or more modules.

In some embodiments, the system 600 comprises a plurality of indoor farming facilities 602, i.e., a first indoor farming facility 602-1, a second indoor farming facility 602-2, a third indoor farming facility 602-3, a fourth indoor farming facility 602-4, and a fifth indoor farming facility 602-5. In some embodiments, each of the plurality of indoor farming facilities 602 comprises a tray-handling system 604 and at least one indoor farming modules 606. In the illustrated embodiments of FIG. 6A, the fifth indoor farming facility 602-5 comprises eight indoor farming modules 606 arranged in four columns and each column comprises two stacked indoor farming modules 606. In alternative embodiments, the autonomous indoor farming system can be implemented in a non-modular system having a single farming facility with a single controlled environment zone. In some embodiments, each of the plurality of indoor farming facilities 602 is further coupled to a remote computer 632 through a communications network 630 (e.g., the Internet).

In some embodiments, the remote computer 632 is a mobile device. In alternative embodiments, the remote computer 632 comprises at least one server computer coupled to a database storing environmental parameters and other data and instructions for analyzing data information provided by each of the sub-systems in each of the indoor farming modules 606 and thereafter provide further instructions for automatically monitoring and controlling the operation of the system 600 described above.

In the illustrated embodiments, the tray-handling system 604 is designed for automatically loading and unloading carts through a first end of the indoor farming module 606. In the illustrated embodiment, the tray-handling system 604 comprises an articulated robot, a linear transfer system, and a robot controller, as described above. In some embodiments, the tray-handling system 604 is configured to transfer a predetermined cart from the chassis in the indoor farming module 606 to a predetermined position (e.g., a storage rack). In some embodiments, when inserting new crops into the indoor farming module 606, the tray-handling system 604 is configured to transfer a predetermined cart from the storage rack to the chassis of the indoor farming module 606.

In some embodiments, the indoor farming module 606 comprises at least one of the following sub-systems: an air circulation system 610, a lighting system 612, an irrigation system 614, a liquid circulation system 618, a controller 620, and a local computer 622. In some embodiments, the liquid circulation system 618 is configured outside of the indoor farming module 606. In some embodiments, the liquid circulation system 618 can be shared by two stacked indoor farming modules 606 and controlled by one of the controllers 620 of the indoor farming modules 606.

In some embodiments, the air circulation system 610 comprises an air blowing unit, an air conditioning unit, an air dehumidifying unit and a sensor. In some embodiments, the air circulation system 610 further comprises a drop ceiling for air flow regulation. In some embodiments, the air blowing unit, the air conditioning unit, the air dehumidifying unit, and the drop ceiling are configured to provide effective regulation of humidity, CO₂ level, gas mixture, air flow, and air temperature for a plurality of plants on each of the plurality of carts at different tiers of the chassis in a grow zone of the indoor farming module 606.

In some embodiments, the irrigation system 614 comprises a plurality of liquid supply conduits, a plurality of liquid return conduits, a plurality of drainage conduits, and a plurality of liquid distribution tube assemblies, as described above. In some embodiments, the irrigation system 614 further comprises valves and stepper motors for controlling the position of the plurality of liquid distribution tube assemblies. In some embodiments, the irrigation system 614 is directly coupled to the liquid circulation system 618.

In further embodiments, the liquid circulation system 618 can include a drainage water reservoir, at least one filter, at least one water reservoir, at least one nutrient reservoir, pumps, a plurality of sensors and a plurality of control units. In some embodiments, the plurality of sensors comprises at least one temperature sensor, at least one pH sensor, at least one electrical conductivity (EC) sensor, and at least one dissolved oxygen (DO) sensor. In some embodiments, the plurality of control units comprises at least one of the following: a temperature control unit, a pH control unit, an dissolved oxygen control unit, a nutrient control unit, each operatively coupled to the plurality of liquid supply conduits and/or the plurality of liquid return conduits for controlling the contents and characteristics (e.g., temperature, pH, etc.) of the liquid flowing through the irrigation system 614. In some embodiments, the liquid circulation system 618 regulates a nutrient level, an oxygen level, a pH level, a temperature, and a particle level in the irrigation liquid to support the growth of plants in the trays of the indoor farming module 606.

In the illustrated embodiment, the lighting system 612 comprises a plurality of lighting modules and each of the plurality of lighting modules comprises at least one of the following photon sources: an incandescent light, a fluorescent light, a halogen light, a high pressure sodium light, a plasma light, and a light-emitting diode (LED) light, so as to provide photons for the photosynthetic reactions in plants. In some embodiments, the photon sources are selected according to a desired light spectrum for the plants. In some embodiments, the lighting system 612 further comprises at least one power supply to power the plurality of lighting modules. In some embodiments, the at least one power supply can be controlled so as to regulate the light intensity, uniformity and light spectrum to provide a desired illumination to the plants in the indoor farming module 606. In some embodiments, the lighting system 612 can further include a plurality of optical sensors for measuring the light intensity, uniformity and light spectrum.

In some embodiments, the indoor farming module 606 further comprises a vision system 616. In some embodiments, the vision system 616 comprises at least one image sensor and at least one light source. In some embodiments, the vision system 616 is configured outside of the indoor farming module 606. In alternative embodiments, the vision system 616 can be also configured in the indoor farming module 606 for monitoring the growth of the plants, as discussed in detail below. The vision system 616 can also include a transfer mechanism. The transfer mechanism can include, for example, a robotic arm, articulating member, track, cylinder or other movable element that can mover the image sensors and/or the light source to desired locations in a farming module 606 to capture data, images and other information that can be used to monitor and/or control the conditions and growing status of the plants in the farming module 606.

FIG. 6B illustrates an exemplary block diagram of a controller 620 in an indoor farming facility, in accordance with some embodiments of the invention. It is noted that the controller 620 is merely an example, and is not intended to limit the invention. Accordingly, it is understood that additional functional blocks may be provided in or coupled to the controller 620 of FIG. 6B, and that some other functional blocks may be omitted or only briefly described herein. It should be also noted that the functionalities provided in each of the components and modules of the controller 620 can be combined or separated into one or more modules.

In the illustrated embodiment, the controller 620 comprises a processor 622, a memory 624, an input/output interface 626, a communications interface 628, and a system bus 634, in accordance with some embodiments. The processor 622 may comprise any processing circuitry operative to control the operations and performance of the indoor farming modules in the indoor farming facility and the tray-handling system. In various aspects, the processor 622 may be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor 622 also may be implemented by a controller, a microcontroller, an application specific integrated circuit (ASIC), a field programmable gate array (FPGA), a programmable logic device (PLD), and so forth.

In various aspects, the processor 622 may be arranged to run an operating system (OS) and various applications. Examples of an OS comprise, for example, operating systems generally known under the trade name of Apple OS, Microsoft Windows OS, Android OS, and any other proprietary or open source OS. Examples of applications comprise, for example, a telephone application, a camera (e.g., digital camera, video camera) application, a browser application, a multimedia player application, a gaming application, a messaging application (e.g., email, short message, multimedia), a viewer application, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in the memory 624.

In some embodiments, the memory 624 may comprise any machine-readable or computer-readable media capable of storing data, including both volatile/non-volatile memory and removable/non-removable memory. The memory 624 may comprise at least one non-volatile memory unit. The non-volatile memory unit is capable of storing one or more software programs. The software programs may contain, for example, applications, user data, device data, and/or configuration data, or combinations therefore, to name only a few. The software programs may contain instructions executable by the various components of the robot controller of the tray-handling system 502 606.

For example, memory may comprise read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory 624 may contain an instruction set, in the form of a file for executing a method of generating one or more timing libraries as described herein. The instruction set may be stored in any acceptable form of machine-readable instructions, including source code or various appropriate programming languages. Some examples of programming languages that may be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processor.

In some embodiments, the I/O interface 626 may comprise any suitable mechanism or component to enable a user to provide input to the indoor farming modules in the indoor farming facility to provide output to the user. For example, the I/O interface 626 may comprise any suitable input mechanism, including but not limited to, a button, keypad, keyboard, click wheel, touch screen, or motion sensor. In some embodiments, the I/O interface 626 may comprise a capacitive sensing mechanism, or a multi-touch capacitive sensing mechanism (e.g., a touchscreen).

In some embodiments, the I/O interface 626 may comprise a visual peripheral output device for providing a display visible to the user. For example, the visual peripheral output device may comprise a screen such as, for example, a Liquid Crystal Display (LCD) screen, incorporated into the indoor farming modules. As another example, the visual peripheral output device may comprise a movable display or projecting system for providing a display of content on a surface remote from indoor farming facility. In some embodiments, the visual peripheral output device can comprise a coder/decoder, also known as a Codec, to convert digital media data into analog signals. For example, the visual peripheral output device may comprise video Codecs, audio Codecs, or any other suitable type of Codec.

The visual peripheral output device also may comprise display drivers, circuitry for driving display drivers, or both. The visual peripheral output device may be operative to display content under the direction of the processor. For example, the visual peripheral output device may be able to play media playback information, application screens for applications implemented on the indoor farming modules, information regarding ongoing communications operations, information regarding incoming communications requests, or device operation screens, to name only a few.

In some embodiments, the communications interface 628 may comprise any suitable hardware, software, or combination of hardware and software that is capable of coupling the indoor farming modules of a plurality of indoor farming facilities to one or more networks and/or additional devices. The communications interface 628 may be arranged to operate with any suitable technique for controlling information signals using a desired set of communications protocols, services or operating procedures. The communications interface 628 may comprise the appropriate physical connectors to connect with a corresponding communications medium, whether wired or wireless.

Systems and methods of communication comprise a network, in accordance with some embodiments. In various aspects, the network may comprise local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery such as a circuit generating system, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fiber Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 628 may comprise one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface may comprise a wireless interface comprising one or more antennas, transmitters, receivers, transceivers, amplifiers, filters, control logic, and so forth.

In various embodiments, the communications interface 628 may provide voice and/or data communications functionality in accordance a number of wireless protocols. Examples of wireless protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may comprise near-field communication techniques and protocols, such as electromagnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

The system bus 634 couples the processor 622, the memory 624, the I/O interface 626, and the communication interface 628 to one another, as necessary. The system bus 634 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MCA), Extended ISA (EISA), Intelligent Drive Electronics (IDE), VESA Local Bus (VLB), Personal Computer Memory Card International Association (PCMCIA) Bus, Small Computer System Interface (SCSI) or other proprietary bus, or any custom bus suitable for computing device applications.

FIG. 7 illustrates a block diagram of an artificial intelligence (AI) system 700 in an autonomous indoor farming system 100, in accordance with some embodiments. In the illustrated embodiment, the AI system 700 comprises three layers, i.e., a data input layer 702, a data processing layer 704, and a data analysis layer 706. In some embodiments, the AI system 700 in an autonomous indoor farming system 100 is configured to perform at least one of the following functions, including evaluating status of crops, precisely measuring plant characteristics, optimizing growing conditions to maximize production yield at minimized cost, and predicting market demand and adjust growing conditions to meet the demand.

In some embodiments, the data input layer 702 collects raw data from various sensors in sub-systems for monitoring growth and health conditions for different plants in different trays of different indoor farming modules 102 from a plurality of farming facilities 602. The growth and health conditions of the plants can be monitored using image sensors in the vision system 616. In alternative embodiments, the growth and health conditions of the plants are monitored by collecting and analyzing soil samples, plant tissue samples, water and air samples. The data input layer 702 can also collect raw data regarding the environmental conditions within the grow zones, including data from an air circulation system 610, a lighting system 612, a vision system 616, and a liquid circulation system 618.

The image sensors in the vision system 616 can be used to capture images of plants with a module 606 during the entire growth process. In some embodiments, the image sensors in the vision system 616 is used to measure plant characteristics so as to identify development stages of plants, to monitor responses from plants to growth environment, for example, nutrient deficiencies (i.e., illness detection). In some embodiments, the image sensors can be based on at least one of the following technologies, including multispectral and hyperspectral imaging, Raman, thermal luminescence, and photoacoustic. In some embodiments, a combination of these image sensing techniques can provide a plant characterization including leaf temperature, leaf water content, leaf thickness/size, leaf color, chlorophyll content and photosynthetic efficiency, etc. In some embodiments, at least one image sensor can be used according to the size of a plant. In some embodiments, a plurality of image sensors can be used for a large plant or for 3-dimensional reconstruction of the plant according to a plurality of 2-dimensional images for determining optimum growth conditions according to the type of the plant. In accordance with various embodiments, various visual characteristics of a plant (e.g., color, size, shape, density, etc.) can be used to determine the health condition or nutrient deficiencies of plants. Examples of such plant characteristics, which can be detected by machine vision and learning systems, are described further below. In some embodiments, the image sensors in the vision system can be used with light sources of the lighting system which provide a light intensity and spectrum for plant growth. In some other embodiments, the image sensors in the vision system work together with separate light sources in the vision system for performing image collection.

The image sensors in the vision system 616 and the other sensors in the lighting system 612, in the irrigation system 614, in the air circulation system 610 and in the liquid circulation system 618 can be used to plant characteristic data 814 and environmental data 816 that can include data and information regarding characteristics of the plants and the environment of the farming modules 606, respectively. The plant characteristic data 814 and the environmental data 816 can be used to determine the health of the plants and the actions that may be necessary to improve the health of the plants, to identify deficiencies in the plants and/or to determine the efficiency and/or productivity of the farming modules 606.

As can be appreciated, the plants that have been planted or are growing in the farming modules 606 can encounter health issues over time that may need to be addressed in order to produce healthy plants that yield crops in desirable amounts to make farming in the farming modules 606 and efficient and profitable alternative to traditional farming. The various sensors of the farming modules 606 can collect information and store such information as plant characteristic data 814 and/or environmental data 816 to determine one or more deficiencies of the plants growing in the farming modules 606. In response to determining or identifying if one or more plants has a deficiency, a remedial action can be recommended and communicated to the controller 620 in order to implement such corrective action in the farming modules 606.

One example deficiency that can be identified by the farming module 606 is a Boron deficiency. Boron is a nutrient that functions to maintain a structural integrity of cells wall, mobilizes sugars to growth points, causes pollen viability and proper seed formations as well as nitrogen fixation in legumes. Indicators of Boron deficiency can include stunting of growth of the plant and new leaves or other new growths can appear distorted or pinched as well as distorted lateral branching may appear. Other indicators of Boron deficiency can include thick and brittle branches and leaves. Still other indicators can include upper growths exhibiting chlorosis manifesting as yellow mottling. Root growth can be limited in plants with Boron deficiency and root tips can appear stubby or with “rat tailing” and root hair development can be limited. Boron deficiency can also be indicated by a decrease in blooms, cork spot and cracking on apple fruit surface. These indicators can appear randomly or spotty across plants in the farming modules 606 and plants can be more susceptible to light damage if exhibiting a Boron deficiency. These indicators can be captured in the plant characteristic data 814 collected by farming module 606.

If a Boron deficiency is identified, the farming module can implement one or more remedial actions to correct this deficiency. Such remedial actions can include the addition of Boron to the growth media, soil or hydroponic solution such as by the addition of a foliar boron spray. Another remedial action can include a balancing of macronutrients to the plants. Still another remedial action can be to correct the pH of the soil or other growth media. Still another remedial action can be to address the leaching of Boron that may occur in sandy-porous soil or in growth media with low organic matter. Still another remedial action can be address Boron immobilization that may occur in clay soils with high iron and aluminum oxide content. Still others can be to reduce over irrigation or to provide moisture to drought or dry root zones. Another remedial action can be to correct a Vapor Pressure Deficit (VPD) that may be out of desirable pressure zone or to raise the temperature of low temperature growth media. These remedial actions can be implemented by the controller 620, for example, in the farming modules 606.

Another example deficiency that can be identified or determined by the farming module 606 is a Calcium deficiency. The proper amount of Calcium can cause proper structural integrity of cell walls and membranes in a plant, can result in proper intracellular messaging and can help regulate the flow of nitrogen and sugars in the plant. Indicators of a calcium deficiency can include a distortion of new growths on the plant such as curling, shepards crook and upward or downward turning of leaves. Other indicators can include necrosis and/or the appearance of scorched edges of leaves. Calcium deficiency, however, often does not generally affect mature leaves on the plant. Other indicators can include stunted plant growth and an underdeveloped root system and the plant tends to wilt easily. Other indicators include an abortion of flows and poor set in fruiting crops. In tomato plants, a calcium deficiency can be indicated by a blossom end rot. In pome fruits, a calcium deficiency can be indicated by brown necrotic spots that can extend in to upper flesh (e.g., a “cork spot”). The sensors of the farming module can collect plant characteristic data 814 that can identify such indicators.

The farming module 606 can implement remedial actions that can address and/or correct a calcium deficiency when such deficiency is identified. The remedial actions that may be implemented can include correcting a pH of the growth media or irrigated liquid to maintain the pH in a desired range. The correction of the pH can also be achieved by applying agriculture lime or sulfur to soil or growth media. Another remedial action can be to raise the Cation Exchange Capacity (CEC) of the soil or growth media. The CEC can be raised by increasing clay and organic matter content in the soil or growth media. Still another remedial action can be to correct the calcium deficiency by adding soluble calcium to the plant root zone. Another remedial action may be to apply nutrients in desired ratios. Another remedial action may be to correct irrigation systems to prevent standing water from occurring. Another remedial action may be to repair the irrigation system to correct a breakage or failure or to change dosing rates and times. Still another remedial action may be to increase calcium levels when nutrient demand increases due to rapid plant growth. This can be particularly important if hydroponic growing is used or during the establishment of plants where high growth is expected to occur. Still another remedial action can be to discontinue the use of nutrient sources that may cause excessive shifts in pH or limit available calcium in the root zone. Another remedial action can be to correct problems associated with environmental control such as problems with temperature, Vapor Pressure Deficit (VPD), air circulation or the like. Yet another remedial action can be to apply foliar calcium spray. These remedial actions can be implemented by the controller 620 and the various systems of the farming module 606.

Another deficiency that can be identified by the farming module 606 is a potassium deficiency. The systems of the farming module 606 can collect plant characteristic data 814 and/or environmental data 816 that can be used to identify the potassium deficiency. Potassium is a nutrient that can maintain cell turgor and help to open and close cell stomata in plants. Potassium, in proper amounts, can also cause proper enzyme activation and leads to the indirect regulation of photosynthesis. Indicators of a potassium deficiency can include older or lower leaves of the plant showing signs of potassium deficiency. The indicators can include a yellowing of leaves or a brown necrosis on leaf edges. Leaf margins can appear scorched in a plant with a potassium deficiency. Indicators can also include a slow plant growth and an underdeveloped root system. Indicators can also include weak stems and stalks and poor fruit quality and yield. Indicators also include a depressed brix percentage in fruit and fruit surfaces may appear rough, dull in color and show blotchy discoloration. Indicators also include signs of the plant being water stressed.

The farming module 606 can implement remedial actions to address a potassium deficiency. The remedial actions can include the correction and repair of control systems. Actions can also include maintaining adequate oxygenation in the plant root zone and improving the CEC of soil or growth media by increasing clay or organic matter content. Other remedial actions can be to apply nutrients in proper ratios relative to each other particularly with respect to calcium and magnesium. Other remedial actions can be to correct a pH to maintain pH in a desired range. The temperature of the water being applied to the plants can be corrected to be within a desired temperature range. Nutrient levels can also be changed to maintain such levels within a predetermined range. Another remedial action can be to correct problems associated with environmental control such as problems with temperature, Vapor Pressure Deficit (VPD), air circulation or the like. These remedial actions can be implemented by the controller 620 and the various systems of the farming module 606.

For example, the various sensors of the air circulation system 610, the lighting system 612, the irrigation system 614, the vision system 616, and the liquid circulation system 618 can be coupled to the controller 620 and/or the local computer 622. The data obtained from these sensors can be collected and stored in a database. As shown in FIG. 8, the computing devices 622 from a plurality of farming facilities 602 can be coupled to a database 802 that can store the data obtained by the various sensors and other information providers shown in data input layer 702. The computing device 622 can include one or more engines or modules that can perform the methods described herein. In the example shown in FIG. 8, the computing device 622 can include a data extraction engine 804, a data processing engine 806 and a farming engine 808. In some examples, the data extraction engine 804 can provide the functionality described with regards to the data input layer 702 and the data processing engine 806 can provide the functionality described with regards to the data processing layer 704. Still further, the farming engine 808 can provide the functionality described with regards to the data analysis layer 706. The data extraction engine 804 can be coupled to the database 802 and to one or more information sources 812. The data extraction engine 804 can obtain the data required to train one or more models that may be included in the farming engine 808 as well as to determine what, if any, remedial actions are necessary to correct deficiencies that may be recognized in the plants growing in the farming modules 606.

The farming engine 808 can include, for example, one or more trained machine learning models 820 that are trained using plant characteristic data 814. The plant characteristic data 814 can include historical data and information that can be used to characterize various aspects of the plants that are growing in the farming modules 606. The plant characteristic data 814 can also include current data and information that can characterize the various aspects of the plants. The current data and information can be used by the trained models 820 in the farming engine 808 to determine which remedial actions may be desired to improve the growing performance of the plants. The current data and information can also be used by the trained models 820 in the farming engine 808 to determine whether one or more deficiencies may be present in the plants growing in the farming modules 606. After such determinations are made by the farming engine 808, the information can be sent to the controller 620, the controller 620 can then implement such actions by sending appropriate farming actions 822 to one or more systems of the farming module 606 such as to the air circulation system 610, the lighting system 612, the irrigation system 614, the vision system 616 and/or the liquid circulation system 618.

Another deficiency that can be identified by the farming module 606 is a magnesium deficiency. The systems of the farming module 606 can collect plant characteristic data 814 and/or environmental data 816 that can be used to identify the magnesium deficiency. Magnesium, in desirable quantities, can cause the proper functioning of many plant enzymes. Magnesium can have an effect of the process of photosynthesis in plants since magnesium atoms are the central component in the structure of chlorophyll which is responsible for harvesting energy from light and converting the energy from photons into chemical energy through electron transport.

Indicators of a magnesium deficiency in a plant can include lower or older leaves becoming pale in comparison to previous colors. The leaves of magnesium deficient plants may appear mottled or may exhibit leaf droop. Further indicators can include necrotic leaf tissue that can appear reddish or purple in color. Indicators may also include interveinal chlorosis in which there is necrotic tissue between the veins of a leaf and leaf senescence or (leaf drop) can occur.

The farming module 606 can implement remedial actions to address a magnesium deficiency. Such remedial actions can include the prevention of root zone drying by modifying an irrigation cycle of the plants. In hydroponic systems, the remedial action can include the draining of liquid from the growth media during each irrigation cycle. Another remedial action can be modifying the pH level of the root zone to ensure that the pH is in a predetermined range. The range, in one example, is a pH of about 5.5 or greater. In another example the pH range is a pH of about 6.5 or lower. In yet another example, the pH range is a range of about 5.5 to about 6.5. In other examples, other ranges can be used.

Another remedial action can be to maintain a level of magnesium ion concentrations at a predetermined level. In one example, the predetermined level of the magnesium ion concentrations is about 25 parts per million (ppm). In another example, the remedial action is to maintain a ratio of magnesium to other nutrients at a predetermined ratio. In one example, the ratio of calcium to magnesium is 3:1, the ratio of potassium to magnesium is about 4:1 and the ratio of potassium to calcium is about 2:1. Another remedial action can be to maintain the PVD at a predetermined level. Still another remedial action can be to prevent damage to plant xylem by maintaining light in a predetermined level, maintaining air movement at predetermined levels and preventing extreme temperatures. Another remedial action can be to drain, flush or recharge nutrient tanks to prevent nutrient imbalances. Yet another remedial action can be to apply a diluted foliar solution of Epsom salts to the plants. Such a foliar solution can include a non-ionic surfactant or spreader/sticker in the solution. These remedial actions can be implemented by the controller 620 and the various systems of the farming module 606.

Another deficiency that can be identified by the farming module 606 is a nitrogen deficiency. The systems of the farming module 606 can collect plant characteristic data 814 and/or environmental data 816 that can be used to identify the nitrogen deficiency. Nitrogen is primary macro nutrient that can result in the proper production of proteins, nucleic acids (DNA and RNA) and chlorophyll in the plant.

The plants can exhibit various indicators that can allow the farming module 606 to identify a nitrogen deficient plant. The indicators of a nitrogen deficiency can include a change in color of the plant. For example, the entire plant can appear to be light green. Another indicator can be a yellowing of older leaves on the plant. Yet another indicator can be a light green or yellow color on emerging growth points on the plant. Another indicator is a stunted growth of the plant. Another indicator is leaf drop. Still another indicator of nitrogen deficiency is necrosis of older leaves and a lack of necrotic spotting. Yet another indicator can be a reduction of crude protein level in plant tissue. Still another indicator is a reddening of leaf petioles and veins.

The farming module 606 can implement remedial actions to address a nitrogen deficiency. The remedial actions can include an addition of nitrogen available to plant roots. Another remedial action can be to correct a pH balance of the soil or growth medium. Still another remedial action can be to correct an imbalance between nitrogen and other nutrients. Another remedial action can be to apply a nitrogen fertilizer appropriate for the plant species, stage of growth and substrate conditions. Still another remedial action can be to apply a foliar nutrient to the plant. Another remedial action can be to add extra nitrogen to soil or growth media in which high carbon organic matter is present in large quantities. Yet another remedial action can be to inspect and repair the monitoring, dosage and irrigations system, including components that are broken, nonfunctional or are out of tolerance. Still another remedial action can be to adjust air circulation and VPD to adjust such conditions into a predetermined range. These remedial actions can be implemented by the controller 620 and the various systems of the farming module 606.

Another deficiency that can be identified by the farming module 606 is a phosphorous deficiency. The systems of the farming module 606 can collect plant characteristic data 814 and/or environmental data 816 that can be used to identify the phosphorous deficiency. Phosphorous is a primary macro nutrient for plants that is an essential component of nucleic acids, plant reproduction, photosynthesis and energy transfer.

The plants can exhibit various indicators that can allow the farming module to identify a phosphorous deficiency. An indicator of a phosphorous deficiency can include a purple discoloration on the leaves and may be especially apparent on the underside of older leaves. Another indicator can be a dark green or purple discoloration on stems and petiole. Another indicator is for the discoloration to being on leaf edges and tips and gradually advance inward. Another indicator is the appearance of leaf tip burn. Yet another indicator is necrotic spotting that may appear near a leaf edge. Still another indicator is leaf drop. Yet another indicator is a reduction in flowing and fruit. Still another indicator is stunted root and plant growth.

The farming module 606 can implement remedial actions to address a phosphorous deficiency. Such remedial actions can include applying phosphorous fertilizer in a soluble form. Another remedial action can be applying phosphorous amendments in advance of crop establishment. Another remedial action can be to adjust and/or correct the pH in the soil, growth medium or nutrient solution. Another remedial action can be to apply phosphorous with ammoniacal nitrogen to increase uptake. Another remedial action can be to adjust or increase amounts of calcium and sulfur to increase phosphorous uptake. Another remedial action can be to raise a nutrient solution temperature if the root zone is below a predetermined temperature level. Another remedial measure can be to apply a organic source of phosphorous to the plant roots. Yet another remedial measure can be to improve root zone aeration. Still another remedial measure can be the foliar application of phosphite. These remedial actions can be implemented by the controller 620 and the various systems of the farming module 606.

Another deficiency that can be identified by the farming module 606 is a sulphur deficiency. The systems of the farming module 606 can collect plant characteristic data 814 and/or environmental data 816 that can be used to identify the sulphur deficiency. Sulphur is a secondary macro nutrient that can assist in amino acid formation, enzyme and vitamin development, seed production, chlorophyll formation, oils formation, volatile compound formation, and nitrogen fixation.

The plants can exhibit various indicators that can allow the farming module 606 to identify a sulphur deficient plant. Indicators of a sulphur deficiency include an overall yell of light green appearance. Another indicator is that yellowing may increase in severity from older to newer leaves. Another indicator is a yellow chlorosis in leaf veins. Another indicator is leaf stripling. Still another indicator is slow or stunted plant growth. Another indicator is necrotic leaf tips. Another indicator is reduced nitrogen fixation in legume plants.

The farming module 606 can implement remedial actions to address a sulphur deficiency. The remedial actions can include supplementing soil, growth media, irrigation water or nutrient solution with sulfur in a predetermined range in sulphate form. Another remedial action can be to measure and apply nutrients with a nitrogen to sulphur ratio at a predetermined level. In one example, the nitrogen to sulphur ratio is about 20:1. Another remedial action can be to monitor, measure and repair the irrigation system to apply an amount of water in a predetermined level. Still another remedial action can be to increase the amount of organic matter in the soil or growth media. Another remedial action is to measure and reduce nitrogen fertilizers that are applied to the plants. Yet another remedial action can be to apply the nutrient solution with a temperature in a predetermined temperature range. Still another remedial action can be to correct the pH level in the soil, growth media or nutrient solution. Still another remedial action can be to adjust the VPD in the farming module 606. These remedial actions can be implemented by the controller 620 and the various systems of the farming module 606.

Referring back to FIG. 7, in some embodiments, the data input layer 702 can obtain raw data including, market data, production yield and food quality. Such data can be obtained from the database 802 or from other information servers or other information sources. Data collected by the data input layer 702 can be used for spatial and temporal analysis. As discussed above, examples of plant characteristic that can be detected, in accordance with various embodiments, are described above. For example, if the data collected by the data input layer 702 indicates the following plant conditions, including stunting of plants, new leaves/growth appear distorted or “pinched,” distorted lateral branching, branches and leaves appearing thick and brittle, yellow molting, root tips appear stubby, decrease in blooms, cork spots or cracking on tissue surface, then that could be an indication of Boron deficiency in the plant. If Boron deficiency is detected, the autonomous indoor farming system, can instruct the control system to undertake any of the following remedial measures: correct soil, media or nutrient solution pH if too high for the given crop(s), run self-diagnostics on all environmental control equipment looking in particular for Vapor Pressure Deficit (VPD), raise nutrient solution temperature, adjust irrigation system to increase the amount of water delivered to the root, apply soluble boron to soil or media, or apply foliar boron sprays. The system then continues to monitor the growth and health condition of the plants and records the effectiveness of the remedial measures.

As shown in FIGS. 9-13, the vision system 616 of the farming module 606 can include image sensors that can collect images of the plants that may be growing in the farming facility 602. The images may be collected to identify one or more deficiencies that may be present in the plants. For example, as shown in FIG. 9, the leaves 900 of a plant may include edges showing a burning or necrosis 902. Such a condition may be an indicator of a calcium deficiency, for example. In another example, as shown in FIG. 10, the images may show a fruit 1000 that may include one or more spots 1002. The blotchy discoloration of the fruit 1000, for example, may be an indicator of a potassium deficiency. In still another example, as shown in FIG. 11, a leaf 1100 of a plant may show an edge that has first condition at an edge zone 1102 and a second condition at an inward zone 1104. The color or other characteristics of the edge zone 1102 and the inward zone 1104 can be an indication of another deficiency of the plant.

Turning now to FIG. 12, a leaf 1200 can show an edge condition and a spotted condition. In this example, the leaf 1200 includes an edge with a discoloration 1202 and with spots 1204. These characteristics can indicate yet another deficiency of the plant. In another example, shown in FIG. 13, the farming module 606 can operate to determine a deficiency of the plant by monitoring a characteristic of the plant over time. For example, the vision system 616 can capture a first image of a plant leaf 1300 at a time 1, a second image of the same plant leaf 1300 at a time 2, a third image of the plant leaf at a time 3 and a fourth image of the plant leaf at a time 4. By comparing the images, the farming module 606 may be able to detect and/or identify a deficiency in the plant by comparing the plant characteristics over time. As shown, the discoloration 1302 is larger at time 3 than at time 2 is larger still at time 4. Thus, the discoloration can be seen to grow over time. The edge 1304 of the leaf 1300 can also be compared over time. As shown, the edge 1304 can be seen to exhibit necrosis. This progression can indicate a deficiency. In this example, the conditions shown can indicate a nitrogen deficiency.

In some embodiments, the vision system 616 can utilize multiple spectrums to detect and collect data reflecting various characteristics of the crops during their growing process. In one example, RGB cameras can be used to collect image data for processing and detection of any anomalies. In another example, LIDAR can be used for detecting and measuring plant growth, using for instance leaf area index and spatial inhomogeneous information. In another example, thermal imaging can be used to detect irrigation and environmental irregularities around the plant leaf (micro climate). In yet another example, hyperspectral imaging can be used for nutrient detection, phenotyping, and measuring water content and phytochemical content. The collected data from the vision system 616 can then be processed in the processing layer 704.

In some embodiments, the data processing layer 704 is configured to perform data pre-processing so as to convert raw data into clean data in a feasible format before it can be fed into the data analysis layer 706. In some embodiments, the data preprocessing performed in the data processing layer 704 includes data rescaling, data binarizing, and data standardizing. In some embodiments, the data preprocessing on images collected by the image sensors in the vision system may include at least one of the following steps: resizing image, removing noise, segmentation, and smoothing.

In some embodiments, alternative computer vision approaches may be used in order to augment the filtering, selection, measurement, and analysis of images. These approaches may include depth-mapping, color filtration and extraction, thermal imaging, infrared spectrum differentiation, and feature matching. High resolution images can be cropped into subsections for higher fidelity analysis and accuracy. All intermediate images and associated data may be permanently stored for future revisions, adjustments, and retraining of artificial intelligence (“AI”) models in data analysis layer 706.

In some embodiments, the data analysis layer 706 is configured to analyze the data collected at the data input layer 702, based on indicators of plant health conditions described above that can be used to evaluate the plant health and growth status. If the system 700, determines that the plants are indicating one of the conditions described above, the system 700 will then instruct control system to implement remedial measures by adjusting specific environment conditions in the grow zone that correspond to the specific detected condition. Accordingly, the AI system 700 can automatically control the conditions of the grow zone to compensate for any nutrient deficiencies, for example, and/or further optimize the growing conditions for the plant within the plant container module.

The AI system 700 can record collected data and monitor the effectiveness of the attempted remedial measures. The data analysis layer 706, compares growth and health characteristics and evaluates the effectiveness of remedial measures. Based on the determined effectiveness of the remedial measures, the AI system 700 learns and modifies its algorithm for determining future remedial steps so as to apply the effective remedial measure and not apply the ineffective remedial measures.

In some embodiments, the AI system 700 may contain a notification system that to notify authorized/responsible personnel concerning observed/detected crop conditions and applicable remedial measures. Additional remedial measures or plant/crop health conditions or statuses that are unaccounted for in the system can be incorporated into AI system 700 by human experts interfacing with the forensics application. Over time, AI system 700 should approach and attain greater autonomy in which corrective actions are taken by the system to avoid potential errors inherent in human operation. In some embodiments, information concerning these actions may be logged and delivered to operational personnel.

In some embodiments, the data analysis layer 706 is configured to perform a machine learning algorithm. In some embodiments, as images are analyzed and categorized by a human operator and saved in a database, machine learning data sets will be accumulated in the database which can be used by an artificial intelligence (AI) algorithm to analyze and categorize future images automatically and make a determination based on such analysis (e.g., based on the image, this plant has a certain nutrient deficiency, etc.)

In some embodiments, the data analysis layer 706 can utilize machine learning models configured in tree structures of progressive complexity to most accurately assess the state of the subject material. In other embodiments, the primary machine learning approaches utilized by data analysis layer 706 may consist of neural networks, deep learning, computer/machine vision techniques, and more conventional machine learning techniques (SVM, KNN, linear regression, logistic regression). The computer vision techniques may include depth-mapping, color filtration and extraction, thermal imaging, infrared differentiation, and feature matching.

In some embodiments, inaccuracies present in the AI models may be corrected by a system-level feedback loop. Existing related structured data may be used to accurately segment ambiguous crop states. Images that are incorrectly labeled or mis-predicted can be fed back through the upper layers of the labeling, training, and model building process (data processing layer 704) to constantly refine the efficacy of the data analysis layer 706.

Turning now to FIG. 14, an example method of autonomous farming 1400 is shown. The methods 1400, 1500 and 1600 can be performed by one or more of the systems or apparatuses described herein, such as by the autonomous farming facility 100, the autonomous farming facility 500 or the autonomous farming facility 600. The steps of methods 1400, 1500 and 1600 can be substantially performed by the computing device 622, for example. In other examples, the steps of methods 1400, 1500 and 1600 can be performed by different computing devices such as servers, computers or other computing devices located either locally or remotely from the farming facility 600. Example computing devices that perform the steps of the methods described herein include computing device 622 and remote computer 632. For the sake of brevity, the method 1400, the method 1500 of FIG. 15 and the method 1600 of FIG. 16 are described with reference to computing device 622 and the farming facility 600. It should be appreciated, however, that the steps can be also be performed by other embodiments and variations thereof as well as being performed by a remotely located shared server, multiple different computing systems and variations thereof.

The method 1400 begins at step 1402 in which the computing device 622 can obtain plant characteristic data 814. The plant characteristic data 814 can be data that characterizes one or more characteristics of the plants growing in the growing containers or farming modules 606. The plant characteristic data 814 can be collected by the sensors in the air circulation system 610, the lighting system 612, the irrigation system 614, the vision system 616 and the liquid circulation system 618. In one example, the plant characteristic data 814 can include an image that is collected by the image sensors of the vision system 616. The image sensors can collect images of the plants in the farming modules 606. The plant characteristic data 814 can be collected and stored in the database 802. The computing device 622 can access and retrieve the plant characteristic data 814 from the database 802 using the data extraction engine 804. The data extraction engine 804 can obtain the plant characteristic data 814 in any suitable manner such as by using appropriate communications methods, application protocol interfaces (APIs) or the like.

The method 1400 continues to step 1404 in which the computing device 622 can obtain environmental data 816. The computing device 622 can, in one example, obtain the environmental data 816 from the database 802 using the data extraction engine 804 in a similar manner to that explained above with respect to the plant characteristic data 814. The environmental data 816 can be data that characterizes the growing conditions inside the farming modules (or growing containers) 606. The environmental data 816 can be collected from the various sensors of the air circulation system 610, the lighting system 612, the irrigation system 614, the vision system 616 and the liquid circulation system 618 and stored in the database 802.

At step 1406 of method 1400, the computing device 622 can perform data processing on the plant characteristic data 814 and/or the environmental data 816. The data processing can be performed by the data processing engine 806. The data processing can process the plant characteristic data 814 and/or the environmental data 816 as described above with regards to the functionality of the data processing layer 704. The data processing can aggregate, organize, structure, standard or perform other data processing to prepare the plant characteristic data 814 and the environmental data 816 to be input into the farming engine 808. As can be appreciated, the farming engine 808 can include one or more machine learning models that can be used to perform other steps of method 1400.

At step 1408 of method 1400, the computing device 622 can determine whether a growing deficiency exists. The computing device 622 can determine a growing deficiency using the plant characteristic data 814 and/or the environmental data 816. In one example, the computing device 622 can include a trained machine learning model 820 for this purpose. The trained machine learning model 820 can be trained using historical plant characteristic data 814 and/or historical environmental data 816. The trained machine learning model 820 can learn indicators of a nutrient deficiency, for example. The nutrient deficiencies discussed above each described indicators that may be identified by the trained machine learning models. In addition, the trained machine learning models can identify and learn complex relationships between the various different data sets in the plant characteristic data 814 and the environmental data 816 to learn indicators for deficiencies that may not otherwise be known. In this respect, the farming engine 808 and the trained machine learning model 820 is a vast improvement over traditional farming methodologies.

A growing deficiency can be any deficiency or condition of the plant or a deficiency or condition in the growing modules 606 that can hinder the healthy and profitable growth of the plants in the growing modules 606. The growing deficiencies can include nutrient deficiencies described above. Other growing deficiencies can include other deleterious conditions such as over- or under-irrigation of the plants, improper air circulation levels, improper drainage, inadequate light, improper balance of nutrients and the like.

At step 1410, the computing device 622 determines whether a growing deficiency exists. If the computing device 622 determines that growing deficiency does not exist, the method returns to step 1402 and the computing device can continue to perform steps 1402 through step 1410 on a continuous or periodic basis. If the computing device 622 determines that growing deficiency exists, the method moves to step 1412.

At step 1412, the computing device 622 can determine a proper farming action based on the growing deficiency. The farming action that is determined by the computing device 622 can be any suitable response that may be necessary to correct or improve the deficiency that is determined at step 1408. The farming action may be a single action such as to modify a nutrient mixture that is applied to the plants. The farming action may also be a combination of actions that can include any number of modifications to the growing conditions in the growing modules 606. The farming engine 808 and/or the machine learning model 820 can learn over time the best or proper farming action to be implemented in light of the deficiencies determined by the computing device 622. Thus, the farming action may change over time as more data is collected and the machine learning model 820 is retrained using, for example, method 1600 explained below.

At step 1414, the computing device can send a farming action 822 to the farming controller 620. The farming action 822 can include an instruction to change one or more growing conditions in the growing modules 606. For example, if the computing device 622 determines that a boron deficiency exists, the computing device 622 can send a farming action 822 to the farming controller 620 that instructs the controller 620 to increase the amount of boron in the nutrients being dispensed to plants in the growing modules 606. As a result of such a farming action 822, the controller 620 can cause the pump in the liquid circulation system 618 to dispense an increased amount of boron from the nutrient reservoir. As can be appreciated, the farming action 822 can include instructions to take any appropriate action using one or more of the air circulation system 610, the lighting system 612, the irrigation system 614, the vision system 616 and the liquid circulation system 618.

At step 1416, the computing device 622 can determine whether the growing process is complete. In some examples, the computing device 622 can determine this based on the amount of time that the plants have been growing. In other examples, the computing device 622 can determine whether the growing process is complete using the plant characteristic data 814. For example, the computing device can determine whether the plant have reached a predetermined size or have produced a predetermined amount of fruit. In still other examples, the computing device may continue to perform the steps of method 1400 until a harvesting command has been received. Regardless, if the computing device 622 determines that the growing process is not complete, the method 1400 returns to step 1402 and the computing device can continuously or periodically perform the method. If the computing device 622 determines that the growing process is complete, the method 1400 ends.

As explained above, the method 1400 can utilize a trained machine learning model 820 to determine the deficiencies that may occur during the growing process of plants in the growing modules 606. The models 820 can, for example, identify conditions of the plants that may result in a less than optimal harvest or a less than optimal productivity and then cause remedial actions to be implemented by the farming system 600 to improve plant growth. As the farming facility 600 operates, the sensors in the air circulation system 610, the lighting system 612, the irrigation system 614, the vision system 616 and the liquid circulation system 618 can continue to collect plant characteristic data 814 and environmental data 816. Such data can also be collected after the farming actions 822 and the associated remedial actions are implemented in the growing modules 606.

Referring now to FIG. 15, another example method of autonomous farming 1500 is shown. The method 1500 includes some aspects that are substantially similar to the steps and functionality described for method 1400. For example, steps 1502 through 1506 can include the same functionality as that described in steps 1402 through 1406 of method 1400.

At step 1508, the computing device 622 can determine a plant growing quality of the plants growing in the growing modules 606. In one example, the plant growing quality can be determined using the plant characteristic data 814. The plant growing quality can correspond to a deficiency as previously described. In other examples, the plant growing quality can identify a health of the plant growing the growing modules 606. Any suitable measures or characteristics can be used to differentiate the health of the plants and to designate a plant growing quality. In one example, the plant growing quality can be indicated by using one or more discrete characteristics of plant health and/or by using clustering. In such examples, the farming engine 808 can use suitable clustering or binning techniques to designate plant health using categories such as excellent, satisfactory or deficient plant health. The plant characteristic data 814 can be used to identify whether a particular plant, a particular cart or a particular growing module is in excellent, satisfactory or deficient plant health.

At step 1510, the computing device 622 can determine a farming action based on the determined plant growing quality. The farming action can be any suitable action as previously described with respect to method 1400. For example, the farming action may be to modify a growing condition inside the farming modules 606. In other examples, the farming action may be to take no action or to continue according to the current growing recipe and current control environment schedule. In still other examples, the farming action may to be acquire further data or information regarding a plant or growing conditions.

At step 1512, the computing device 622 can decide if the farming action requires modification of growing conditions in the farming module 606. If the computing device 622 determines that a modification is required the method moves to step 1514. If the computing device 622 determines that a modification to growing conditions is not required, the method moves back to step 1502. In this manner, the method 1500 provides for a continuous or period monitoring of the plant growing quality of the plants in the farming modules 606.

At step 1514, the computing device 622 can send the farming action to the farming controller 620 to implement the modification to the growing conditions in the farming module 606. As can be appreciated, the farming action can include instructions to take any appropriate action using one or more of the air circulation system 610, the lighting system 612, the irrigation system 614, the vision system 616 and the liquid circulation system 618 as previously described.

At step 1516, the computing device 622 can determine whether the growing process is complete. In some examples, the computing device 622 can determine this based on the amount of time that the plants have been growing. In other examples, the computing device 622 can determine whether the growing process is complete using the plant characteristic data 814. For example, the computing device can determine whether the plant have reached a predetermined size or have produced a predetermined amount of fruit. In still other examples, the computing device may continue to perform the steps of method 1500 until a harvesting command has been received. Regardless, if the computing device 622 determines that the growing process is not complete, the method 1500 returns to step 1502 and the computing device can continuously or periodically perform the method. If the computing device 622 determines that the growing process is complete, the method 1500 ends.

Turning now to FIG. 16, a method 1600 for improving an autonomous farming system is shown. The method 1600 begins at step 1602 in which the computing device 622 can obtain historical plant characteristic data. The historical plant characteristic data can be substantially similar to the plant characteristic data 814 previously described. The historical plant characteristic data can also include data collected subsequent to training data set that was used to train the machine learning model 820 that is actively being using in the farming system 600. The historical plant characteristic data can be obtained using any suitable method such as that previously described for the plant characteristic data 814.

At step 1604, the computing device 622 can obtain historical environmental data. The historical environmental data can be substantially similar to the environmental data 816 previously described. The historical environmental data can include environmental data collected subsequently to the data set used to initially train the machine learning model 820.

At step 1606, the computing device 622 can re-train the machine learning model 820 using the historical plant characteristic data and the historical environmental data. While not shown, the historical plant characteristic data and the historical environmental data can be processed by the data processing engine 806 as described with respect to the data processing layer 704. The machine learning model 820 can be re-trained to take advantage of an increased amount of data that is available since data has continued to be collected by the various sensors of the farming modules 606. The re-training of the machine learning model 820 can result in a re-trained machine learning model that may identify different, additional or revised relationships from the historical plant characteristic data and the historical environmental data. Any suitable open source or proprietary machine learning tools or libraries can be used to re-train the machine learning model 820.

At step 1610, the computing device 622 can determine whether the performance of the re-trained machine learning model exceeds the performance of the initially trained machine learning model. In order to determine the performance of the models, any suitable performance metrics can be used. For example, a traditional A-B test methodology can be used to compare the models. In other examples, the re-trained and the initial models can be compared using a common data set of plant characteristic data and environmental data and then compared to determine whether the models are able to accurately identify known deficiencies that were encountered during actual operation of the farming system 600. In still other examples, other performance measures can be used.

If the computing device 622 determines that the re-trained model does not perform better than the existing or initial model, the initial model is kept in operation at step 1616 and the method moves to step 1614. If the computing device 622 determines that the re-trained model performs better than the initial model, the method moves to step 1612.

At step 1612, the computing device 622 can replace the initial model with the re-trained model. After this replacement, the farming system 600 can continue to operate with the re-trained model.

At step 1614, the computing device can determine whether a predetermined time period has elapsed. As can be appreciated, the operator of the farming system 600 can continuously improve the performance of the system by allowing the machine learning model 820 to continuously take advantage of the increased amounts of plant characteristic data and the environmental data that are collected during operation of the farming system 600. Thus, on a periodic basis, the method 1600 can be performed to determine if the newly available data improves the performance of the machine learning model 820. Thus, the computing device 622 may determine whether such predetermined time period has passed. Any suitable predetermined time period can be used such as one week, one month, two months, three months, six months, twelve months or other time periods. Thus, if the predetermined time period has not elapsed, the computing device 622 waits for such time period. When the predetermined time period has passed, the method returns to step 1602 to re-perform the previously described steps to determine if improvements can be made to the operation of the farming system 600. In other examples, the computing device 622 can wait to re-perform method 1600 until it determines that a sufficient amount of historical plant characteristic data and/or a sufficient amount of historical environmental data is available to allow the re-training of the machine learning model 820.

The methods, systems and apparatuses of the present disclosure are improvements over traditional methods and systems. The examples described herein include structures and functionality that is not otherwise known. The autonomous farming facilities of the present disclosure allow growers to not only operate large scale facilities with little to no human intervention and can include the capability to collect vast amounts of data and information regarding plant characteristics, growing trends, environmental impact to plant growth as well as the impact of remedial actions when deficiencies are identified and addressed in large scale farming operations. The implementation of machine learning models in the context of autonomous farming can improve the consistency, production and profitability associated with the operation of large-scale indoor farming. The implementation of machine learning models in this context is a vast improvement over known methods because of the unique aspects of the indoor growing environments and arrangement thereof described herein. Furthermore, the methods and functionality described cannot be performed under traditional farming methods because the machine learning models can identify relationships among the data that are otherwise unrecognizable by traditional farming methods. The implementation of the methods and systems described herein can result in improved crop production, improved profitability and improved output over traditional methods.

While various embodiments of the invention have been described above, it should be understood that they have been presented by way of example only, and not by way of limitation. Likewise, the various diagrams may depict an example architectural or configuration, which are provided to enable persons of ordinary skill in the art to understand exemplary features and functions of the invention. Such persons would understand, however, that the invention is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the invention should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two, which can be designed using source coding or some other technique), various forms of program or design code incorporating instructions (which can be referred to herein, for convenience, as “software” or a “software module), or combinations of both. To clearly illustrate this interchangeability of hardware and software, various illustrative components, blocks, modules, circuits, and steps have been described above generally in terms of their functionality. Whether such functionality is implemented as hardware, firmware or software, or a combination of these technique, depends upon the particular application and design constraints imposed on the overall system. Skilled artisans can implement the described functionality in various ways for each particular application, but such implementation decisions should not be interpreted as causing a departure from the scope of the invention.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “engine” as used herein, refers to software, firmware, hardware, and any combination of these elements for performing the associated functions described herein. Additionally, for purpose of discussion, the various engines are described as discrete engines; however, as would be apparent to one of ordinary skill in the art, two or more engines may be combined to form a single engine that performs the associated functions according embodiments of the invention.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

The term “model” as used in the present disclosure includes data models created using deep-learning. Deep-learning is a type of machine learning that may involve training a model in a supervised or unsupervised setting. Deep-learning models may be trained to learn relationships between various groups of data. Deep-learning models may be based on a set of algorithms that are designed to model abstractions in data by using a number of processing layers. The processing layers may be made up of non-linear transformations. Deep-learning models may include, for example, neural networks, convolutional neural networks and deep neural networks. Such neural networks may be made of up of levels of trainable filters, tranformations, projections, hashing, and pooling. The deep learning models may be used in large-scale relationship-recognition tasks. The models can be created by using various open-source and proprietary machine learning tools known to those of ordinary skill in the art.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein.

What is claimed is:

1. An autonomous farming system comprising a computing device that is configured to:
obtain plant characteristic data that characterizes one or more plant characteristics of a plant growing in at least one growing module;
determine at least one growing deficiency of the plant based on the plant characteristic data using a farming engine; and
send at least one farming action to a farming controller operatively coupled to the at least one growing module, wherein the at least one farming action comprises a remedial action to improve growing conditions of the plant.

2. The autonomous farming system of claim 1, wherein the farming engine comprises a trained machine learning model.

3. The autonomous farming system of claim 1, wherein the plant characteristic data is collected by one or more sensors located in the at least one growing module.

4. The autonomous farming system of claim 1, wherein the computing device is configured to obtain plant environmental data characterizing the growing conditions of the plant inside the at least one growing module and the at least one growing deficiency is determined based on the plant environmental data.

5. The autonomous farming system of claim 4, wherein the farming engine comprises a machine learning model trained using historical plant characteristic data and historical environmental data.

6. The autonomous farming system of claim 1, wherein the farming controller is operatively coupled to at least one of an air circulation system, a lighting system, an irrigation system, a vision system and a liquid circulation system.

7. The autonomous system of claim 6, wherein the at least one farming action includes instructions that cause the at least one of the air circulation system, the lighting system, the irrigation system, the vision system and the liquid circulation system to change the growing conditions in the growing module.

8. The autonomous farming system of claim 1, wherein the plant characteristic data comprises image data collected by a vision system in the growing module, the image data including images of the plants in the growing module.

9. The autonomous farming system of claim 8, wherein the farming engine automatically determines the at least one deficiency of the plant based on historical image data.

10. The autonomous farming system of claim 1, wherein the computing device is configured to re-train a machine learning model of the farming engine and replace an initial machine learning model with a re-trained machine learning model when the computing device determines that a performance of the re-trained machine learning model exceeds a performance of the initial machine learning model.

11. The autonomous farming system of claim 1, wherein:
the at least one growing module comprises a plurality of growing containers;
the plurality of growing containers are arranged in at least two columns and at least two rows to define a matrix of growing containers; and
the computing device is configured to obtain plant characteristic data that characterizes one or more plant characteristics of a plant growing in each of the plurality of growing containers.

12. A method of autonomous farming comprising:
obtaining plant characteristic data that characterizes one or more plant characteristics of a plant growing in at least one growing module;
determining at least one growing deficiency of the plant based on the plant characteristic data using a farming engine; and
sending at least one farming action to a farming controller operatively coupled to the at least one growing module, wherein the at least one farming action comprises a remedial action to improve growing conditions of the plant.

13. The method of claim 12, wherein the farming engine comprises a trained machine learning model.

14. The method of claim 12, wherein the plant characteristic data is collected by one or more sensors located in the at least one growing module.

15. The method of claim 12, further comprising obtaining plant environmental data characterizing the growing conditions of the plant inside the at least one growing module and determining the at least one deficiency further based on the plant environmental data.

16. The method of claim 12, wherein the farming engine comprises a machine learning model trained using historical plant characteristic data and historical environmental data.

17. The method of claim 12, wherein the farming controller is operatively coupled to at least one of an air circulation system, a lighting system, an irrigation system, a vision system and a liquid circulation system.

18. The method of claim 17, wherein the at least one farming action includes instructions that cause the at least one of the air circulation system, the lighting system, the irrigation system, the vision system and the liquid circulation system to change the growing conditions in the growing module.

19. The method of claim 12, wherein the plant characteristic data comprises image data collected by a vision system in the growing module, the image data including images of the plants in the growing module.

20. The method of claim 19, wherein the farming engine automatically determines the at least one deficiency of the plant based on historical image data.

21. The method of claim 12, further comprising re-training an initial machine learning model of the farming engine and replacing the initial machine learning model with a re-trained machine learning model when the computing device determines that a performance of the re-trained machine learning model exceeds a performance of the initial machine learning model.

22. The method of claim 12, wherein:
the at least one growing module comprises a plurality of growing containers;
the plurality of growing containers are arranged in at least two columns and at least two rows to define a matrix of growing containers; and the method further comprises:
obtaining plant characteristic data that characterizes one or more plant characteristics of a plant growing in each of the plurality of growing containers.

23. An autonomous farming apparatus comprising:
a plurality of enclosed growing containers each comprising an independently controllable environment wherein the plurality of enclosed growing containers are oriented in at last two columns and at least two rows to define a matrix of growing containers;
at least one movable cart positioned in each of the plurality of enclosed growing containers, each of the at least one movable cart configured to hold one or more plants; and
an articulated robot movably positioned on a track and on a riser, the articulated robot configured to move in a first direction along the track to access each column in the matrix of growing containers and to move in a second direction along the riser to access each row in the matrix of growing containers.

24. The autonomous farming apparatus of claim 23, wherein the articulated robot is configured to extract and insert the at least one movable cart from each growing container in the matrix of growing containers.

25. The autonomous farming apparatus of claim 23, wherein each growing container in the matrix of growing container comprises at least two tiers configured to support the at least one movable cart at different positions relative to a bottom of the growing container.

26. The autonomous farming apparatus of claim 23, further comprising a computing device and a farming controller, the computing device coupled to the farming controller and configured to determine at least one deficiency of the one or more plants using a trained machine learning model.

27. The autonomous farming apparatus of claim 26, wherein the computing device determines the at least one deficiency based on plant characteristic data obtained from one or more sensors located in each of the growing containers.

28. The autonomous farming apparatus of claim 27, wherein the computing device determines the at least one deficiency further based on environmental data obtained from one or more sensors located in each of the growing containers.

29. The autonomous farming apparatus of claim 28, wherein the machine learning model is trained using historical plant characteristic data and historical environmental data obtained from sensors located in each of the growing containers.

30. The autonomous farming apparatus of claim 29, wherein the computing device is further configured to send a farming action to one of an air circulation system, a lighting system, an irrigation system, a vision system and a liquid circulation system located in one of the plurality of growing containers to cause the one of the air circulation system, the lighting system, the irrigation system, the vision system and the liquid circulation system to change a growing condition in the one of the plurality of growing containers.
